(19) United States
(12) Patent Application Publication
(10) Pub. No.: US 2015/0356130 A1
(43) Pub. Date: Dec. 10, 2015

(54) DATABASE MANAGEMENT SYSTEM

(71) Applicant: FACE RECORDING AND MEASUREMENTS, LTD., Nottingham (GB)

(72) Inventors: Paul CLIFFORD, Nottingham (GB); Rory BHANDARI, Nottingham (GB); Toby ROGERS, Nottingham (GB)

(73) Assignee: FACE Recording and Measurements, Ltd., Nottingham (GB)

(21) Appl. No.: 14/763,325

(22) PCT Filed: Jan. 24, 2014
(86) PCT No.: PCT/EP2014/051423

§ 371 Date: Jul. 24, 2015

Related U.S. Application Data
(60) Provisional application No. 61/756,484, filed on Jan. 25, 2013.

(51) Int. Cl. G06F 17/30

(52) U.S. Cl. CPC G06F 17/30327; G06F 17/30339; G06F 17/30395; G06F 17/30424; G06F 17/30864; G06F 17/30569

(57) ABSTRACT

A method of operating a database system access to plurality of heterogeneous databases, each of said databases having a structure based on a respective database model and storing a plurality of data entities having attributes and occurrences within the structure; providing an interface database, the interface database populated with a plurality of unique, multi-character expressions associated with the data entities of plurality of databases, whereby the plurality of unique, multi-character expressions are defined by assigning to every entity, every attribute and every entity occurrence a unique, multi-character expression, the expression having a predetermined hierarchical structure which defines the relationship between each entity, attribute and entity occurrence with every other entity, attribute and entity occurrence in the interface database and storing said expressions in an expression set table linking each element of each expression to a hierarchical level and a position in a data model.

### TECHNICAL FIELD

The present invention relates to database systems, in particular to a database system that provides an interface database with a hierarchical tree-like structure using data from a plurality of other databases which heterogeneous in nature. The use of an interface database that comprises a set of homogeneous expressions that correspond to original data in the heterogeneous databases enables fast and comprehensive data extraction, querying and output display functions from databases which may be based on different database models. In this way the present teaching provides efficient methods of collating data from multiple source databases into a structure that makes for flexible and straightforward analytical interrogation without requiring complex mapping processes that are both time-consuming and force upfront decisions as to the relationships between similar data elements.

### BACKGROUND

A database model is a theory or specification describing how a database is structured and used. A data model is not just a way of structuring data: it also defines a set of operations that can be performed on the data such as queries. Several such models have been suggested such as Hierarchical model, Network model, Relational model (the most popular model), Entity-relationship model, Object-relational model, Multivalue model, Object Model and Document model.

As is well known, there is a lack of standardisation of database models and systems such that different organizations use different database models or even different departments within an organization (e.g., the Health Service) use different database models. Each organization or department generally chooses the database model considered most suitable for them or simply accepts the database model recommended to them by their IT department or database manager/administrator. Furthermore it is generally not possible to manage databases having different database models using one database management system.

Well known database models and systems include those provided by Oracle™, Microsoft™, Sybase™, IBM™ and the like. Each differ in specifics and typically require an expertise in maintaining and interrogating data within their defined data structures.

These databases are known and usefully employed to aggregate data in a manner that has become known in the art as big data analytics. This is where large data sets are examined or interrogated to uncover hidden patterns, correlations, or other trends of information categories. A problem that exists with big data is that the actual examination of the data typically requires expertise in computing analysis, tools that are specific to the database type and a knowledge of the data structures within the databases. There are fundamental problems in the world of big data of collating data from multiple source databases into a structure that makes for flexible and straightforward analytical interrogation. Traditional methods depend upon complex mapping processes that are both time-consuming and force upfront decisions as to the relationships between similar data elements.

Another problem that exists with traditional approaches pertains to the fact that while the approaches require complex mapping it is often desirable to avoid mapping decisions in the first instance because decisions regarding whether to treat two data elements from different sources as identical may only be sensibly made by undertaking analyses of various types within a collated database. Traditional methods force mapping judgments in advance of the data being in a single place that supports such analyses.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY

Accordingly, the present teaching provides a database system which configures a database model with a hierarchical tree-like structure using data from a plurality of heterogeneous databases. The plurality of different databases can each be structured according to a different database models. By providing an intermediary data structure (database) between a user of the databases and the stored data the present teaching recognises that the use of multi-character expressions can be adapted and extended to provide access to data stored within each of the different database models through use of a single interrogatory syntax. The present teaching also utilises an insight as to how the multi-character expressions may be generated in the first instance.

In accordance with the present teaching the intermediary data structure is provided as a storage model based on a conceptual data model in accordance with a hierarchical structure. Every entity, every attribute and every entity occurrence within each of the underlying databases is assigned a unique, multi-character expression which defines the relationship between each entity, attribute and entity occurrence with every other entity, attribute and entity occurrence in the database and may also uniquely define an attribute value to an occurrence of an entity. The expressions are stored in an expression set table linking each element of each expression with a natural language phrase relating the expression to a hierarchical level and a position in a data model. The “expressions” used are multi-character expressions conveniently divided into a number of “words”, each of a number of bytes.

Each multi-character expression indicates a context (in the data model), a specification (e.g. a description/definition of the data being encoded) and a quality (e.g. actual data values or pointers thereto). Where any of these components are unknown or irrelevant, a wildcard character or “non-deterministic” character can be used. A feature of the expressions used to describe the data model is that similar data structures can be replicated throughout the main tree of multi-character expressions by changing only selected characters in the expression. Such an arrangement is similar to that discussed in detail in the patent GB 2293667B, and in subsequent related patent GB 2398143B the contents of which are incorporated herein by way of reference. By using multi-character expressions to store data in an intermediate or interface database, the present teaching provides a homogenous set of data that provides access to data that is otherwise stored in heterogeneous forms. In this way it offers extremely fast searching and context switching capability when accessing data from the underlying plurality of heterogeneous databases.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE FIGURES

The present invention will now be described by way of example, and with reference to the accompanying drawings in which:

FIG. 1 shows an exemplary database system described in accordance with the present teaching;

FIG. 2 shows an exemplary data model of the interface database;

FIG. 3 shows an overview of the use of an expression set together with the implementing tables of the database system of the present teaching; and

FIG. 4 shows another exemplary database system described in accordance with the present teaching.

### DESCRIPTION OF EXAMPLE ASPECTS/EMBODIMENTS

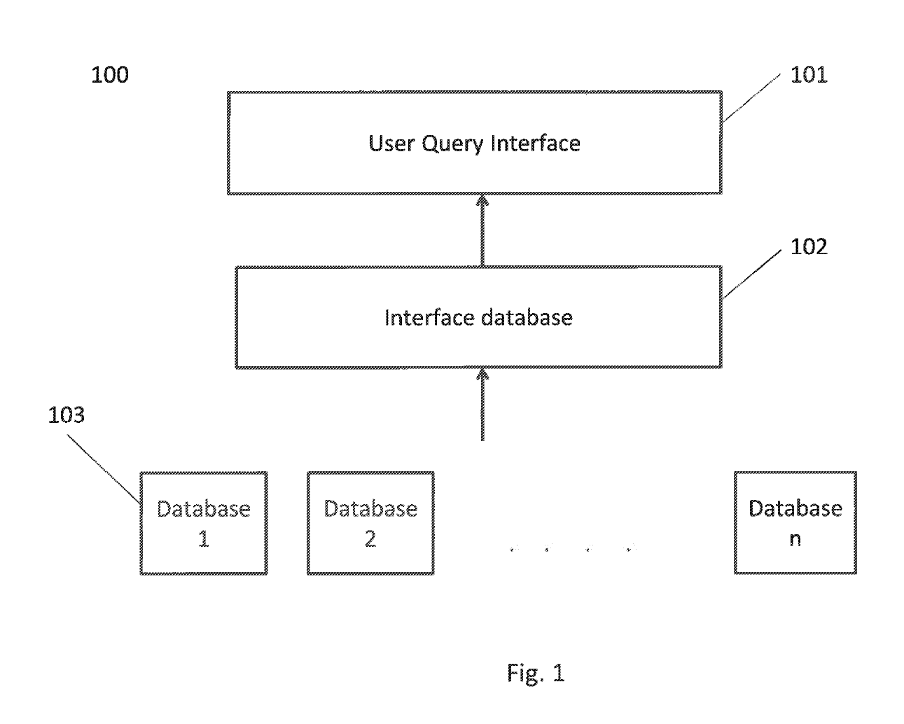

In order to overcome the limitations of the current state of the art there is provided in the present application a method of operating a database system. FIG. 1 depicts such a database system 100. It can be seen that access to a plurality of databases 103 is provided. Furthermore each of the databases 103 can have a structure based on a respective database model such that the structures of individual ones of the databases are heterogeneous. Any conventional database model can be used for databases 103 e.g., the above mentioned relational models etc. As is well known to those skilled in the art each database stores a plurality of data entities having attributes and occurrences within the structure of the database. However, in these existing plurality of databases, the structure of the data is often specific to that database and requires decisions a priori to the population of the databases as to structure and relationships of individual pieces of data to other pieces of data.

Although a plurality of databases 103 are shown in FIG. 1, a single database 103 can also be used. Furthermore, when using a plurality of databases 103, at least two can differ in their database management system such that each database management system defines a set of programs that enable a user to store, modify, and extract information from the respective database.

The database management systems used for the databases 103 can be selected from one or more widely used database platforms such as those provided by Oracle, FoxPro, IBM DB2, Linter, Microsoft Access, Microsoft SQL Server, MySQL, PostgreSQL and SQLite or other types as will be appreciated by those of skill in the art which may be provided on dedicated network or cloud environments. These type of databases may include no SQL type databases and traditional database based on relational structures.

Database system 100 also includes an interface database 102, whereby the interface database 102 is populated with a plurality of unique, multi-character expressions associated with the data entities of the at least one database 103. In this way the interface database provides a homogeneous representation of the data within the individual ones of the plurality of databases 103. Details of the structure of this interface database 102 are described in more detail below.

By using an interface database the present teaching provides a decomposition of the contents of multiple database into sets of events each of which are associated with sets of multi-character expressions. In this a method and database structure in accordance with the present teaching facilitates both extended and point in time events, the specifics of which may be determined at the time of interrogation of the data as opposed to at the time of creating the databases. It will be appreciated that an extended event is an event where the duration of the event is important to the context and recordal of the event. For example in a healthcare context, the duration of a patient stay is an important feature which needs to be recorded. In contrast, the points in time and how often a person's vital signs are taken while in hospital have importance but how long it took to take the vital signs on each occasion is not. Using the present teaching, complex inter-relationships based on extended events and point in time occurrences can be analysed and interrogated through use of natural language deterministic queries, as will be apparent from the following disclosure. This is of particular importance in healthcare and other domains where the relationships and effects of complex sequences of events are critical to analytical enquiry. For example, the relationship between date of first occurrence of symptoms, date of 1^{st} diagnosis of an illness, date of initial treatment may have an impact on subsequent admission or readmission to hospital and length of survival. In conventional databases the analysis of such queries is complex and analysis of any one set of relationships between events typically involves creation of a new complex query. In the present invention, by means of simply recording ‘event ID’ to link sets of multi-character expressions that specify when an event occurred and the content of that event, it is possible to construct highly generic natural language queries that examine the relationships between any sequence of events, thereby resulting in a massive simplification of the analytical process.

Also shown in FIG. 1 is a user query interface 101. The user query interface 101 is configured to effect generation of data query expressions. It can be understood that one of the main objectives of the present teachings is to allow a user to access data stored in the plurality of databases 103 without using the database management system specific to the plurality of databases 103 but rather using the interface database 102 accessed through the user query interface 101. This takes advantage of faster searching and context switching capability of the interface database 102 and is a clear advantage over simply querying the databases 103 directly.

In order to achieve the aforementioned objective of the present teachings—allow a user to access data stored in the plurality of databases 103 using the interface database 102 accessed through user query interface—then the data stored in the plurality of databases 103 must be converted into unique, multi-character expressions for storage in the interface database 102. The details of implementing such a conversion can be chosen as appropriate by one skilled in the art. However, one possible implementation involves iteratively accessing data within the plurality of databases 103 to convert data not already converted and stored as unique, multi-character expressions in the interface database 102 to unique, multi-character expressions for storage in the interface database 103. The frequency of these intervals can be set by the interface database 102 administrator/manager as appropriate. For example, where data is not frequently altered/updated in databases 103 then interface database 102 can be updated during quiet processing times such as during the night. Another possible implementation for updating the interface database involves updating the interface database 102 each time data on one of the plurality of databases 103 is updated such that the interface database 102 is updated on a determination that one of the plurality of databases 103 has been updated. However, where one or more of databases 103 exists in a high volume data changing/altering environment then this can place an undesirable load on the processing resources of the interface database 102. It can also be understood that maintaining the plurality of databases 103 can occur concurrently with maintenance of the interface database 102.

The plurality of databases 103 and the interface database 102 do not have to be provided at the same geographical location and usually such that at least one of the databases 103 and interface database 102 can be provided as a cloud database.

Now, turning to a more detailed discussion of the structure of the interface database 102, the plurality of unique, multi-character expressions are defined by assigning to every entity, every attribute and every entity occurrence a unique, multi-character expression, the expression having a predetermined hierarchical structure which defines the relationship between each entity, attribute and entity occurrence with every other entity, attribute and entity occurrence in the second database.

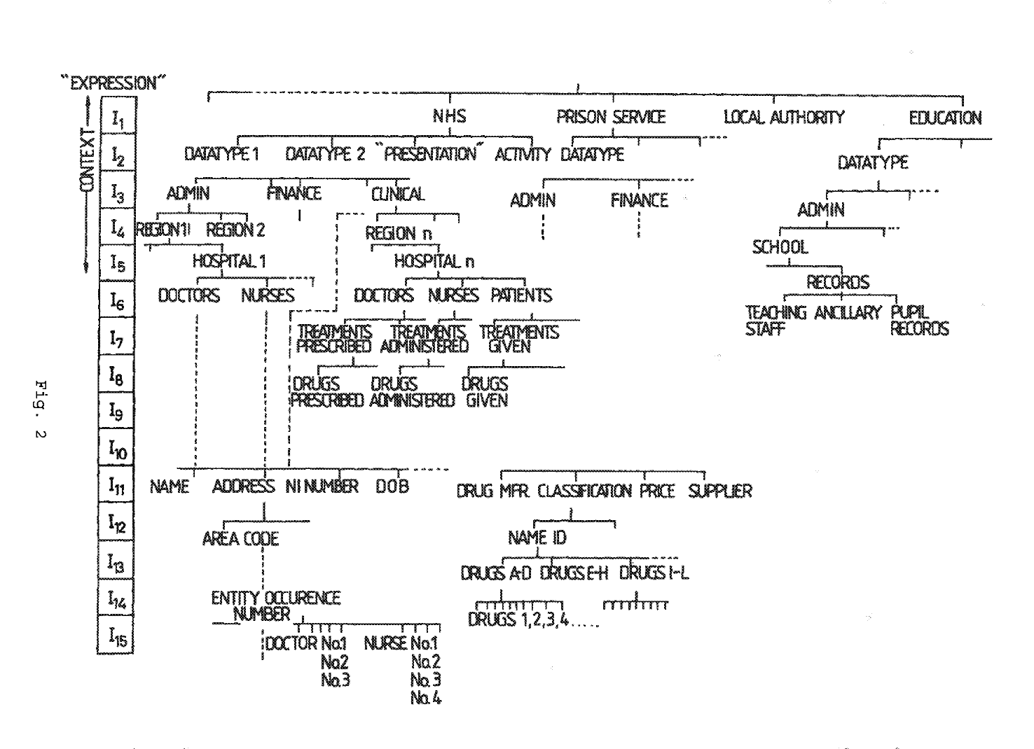

The way in which the database structure of the interface database 102 is imposed by the assignment of these expressions is best described with reference to an exemplary data model as shown in FIG. 2.

The tree structure in FIG. 2 represents the complete data model. Each hierarchical level of the data model is shown horizontally across the tree structure, and each one of these hierarchical levels may be represented by an appropriate byte I₁, to I₁₅ of the expression shown vertically on the left hand side of the drawing. It will be understood that the number of bytes representing a character in the expression, or the length of the overall expression, can be varied according to the requirements of a particular system. At the highest level of the tree I₁, context information is shown defining the organization from which the data was provided, for example the National Health Service (NHS), Prison Service, Local Authority, Educational Establishment etc.

It can be understood that the data for constructing the interface database 102 is provided from respective databases for each of the National Health Service (NHS), Prison Service, Local Authority, and Educational Establishment. In particular, it should be understood that each of these organization uses at least one database corresponding to the databases 103 of FIG. 1. However, it should also be understood that the database system 100 can be directed to one of these organizations e.g., National Health Service (NHS) such that at the highest level of the tree I₁, context information is shown defining the department or section of the NHS from which the data was provided.

As outlined above, the first byte I₁ in every multi-level expression to designate the organization or database installation from which data is being imported. This enables simple use of filters and masks relating to this byte, for example to prevent or enable one organization querying the receiving database from viewing data belonging to another organization etc. Obviously, once data has been collated in the interface database 103 from the plurality of databases 103 access to portions of the imported data must be limited. For example, a user of the interface database 103 should not be able access all the data across multiple organizations. In particular, a user of the interface database 103 who is only permitted to query or access files related to the health service will have the first byte I₁ restricted to that used by the health service. Therefore, any query that the user makes is limited to only the health service i.e., only data of the health service is searched. Further restrictions can be placed on the user by restricting other bytes further down on the multi-character expression such that a user is restricted to queries within departments of an organization. The significance of byte I₂ is discussed in more detail in GB 2293697B and GB 2398143B, but broadly speaking indicates a data type from a plurality of possible data types that might be used.

Within each organization (e.g. the Health Service or health administration organization) there may typically be a number of departments or functions or data view types (represented by byte I₃) such as administration, finance/accounts and clinical staff, all of whom have different data requirements. These different data requirements include:

a) different data structures or models pertaining to different organizational hierarchies within the department;
b) different views of the same entities and occurrences of entities; and
c) the same or different views of “standard format” data relating to different occurrences of similar or identical entities or attributes.

Within such organizations it is also possible that there are more conceptual constructs of the data such as allowing an association of data with multiple non-traditional search criteria. For example in the context of healthcare, while it may be known to associate a specific patient with a specific treatment and then a specific doctor such that a search query would use the patient as the key or root to the search string, the present teaching facilitates the use of any of the three elements as a route to a previously non determined relationship, i.e. a search query could be constructed that was constrained on any of patient, treatment or doctor as opposed to the traditional query that had to be constrained by patient only.

By decomposing the originating data into multi-character expressions where each character of the multi-character expression is independently searchable of others of the characters, the interface database 102 accommodates these differences in the underlying organizations/departments and their corresponding databases. The significance of this to the present teaching will become clear as one progresses downward through the hierarchy.

Each department may wish to segregate activities (e.g. for the purpose of data collection and analysis) to various regional parts of the organization: e.g. a geographically administered area or a sub-department. This can be reflected in the structure of the interface database 102 by expression byte I₄. Each geographically administered area may further be characterized by a number of individual unit types, such as: (i) hospitals, health centres etc. in the case of an health service application; (ii) schools or higher education institutions in the case of an education application; (iii) prisons and remand centres in the case of the prison service application.

Each of the organizations and units above will have different data structure requirements (as in (a) above) reflecting different entities, attributes and entity relationships within the organization and these are provided for by suitable allocation of codes within the I₆ to I₁₀ range of expression bytes. In this case, the same alphanumeric codes in bytes I₆ to I₁₀ will have different meaning when in a branch of the tree under for example a structure such as that provided by the National Health Service (NHS) in the UK, than when under, e.g. the education branch, even though they exist at the same hierarchical level. As an example, the sub-tree structure represented by particular values of bytes I₆ to I₁₀ may refer to patient treatment records in the NHS context, whereas those values of codes may refer to pupil academic records in the education context.

However, in the case of (b) above, where the organizational unit requires the same or different views of the same entities, attributes and occurrences of entities as other organizational units, the codes in bytes I₆ to I₁₀ of one branch of the tree will represent the same underlying structure and have the same meaning as corresponding byte values under another branch of the tree. An example of this is where both the administration departments and the finance departments require a view of the personal details of the staff in the hospital, both doctors and nurses. Note that the views of the data may be the same or different for each department, because the view specification is inferred from the higher level I₁ to I₅ fields. In this case, for entities, attributes and occurrences of entities which are the same in each sub-branch, some or all of the codes I₁ to I₅ which identify each entity occurrence will have identical values.

In the case of (c) above, i.e. the same or different views of standard format data relating to different occurrences of similar or identical entities and their attributes, it will be understood that a number of predefined bytes require the same specification regardless of the particular organization using them. For example, a sub-tree relating to personnel records, and including a standard format data structure for recording personnel names, addresses, National Insurance numbers, sex, date of birth, nationality etc. can be replicated for each branch of the tree in which it is required. For example, all of the organizations in the tree will probably require such an employee data sub-tree, and thus by use of standardised codes in bytes I₆ to I₁₀ such organizational sub-trees are effectively copied into different parts of the tree. However, in this case, the context information in fields I₁ to I₁₅ will indicate that within each organization, we are actually dealing with different occurrences of similar format data.

The tree structure defined by the expressions I₁ to I₁₅ can be used to define not only all entity types, all entity attribute types and all entity occurrences, but can also be used to encode the actual attribute values of each entity occurrence where such values are limited to a discrete number of possible values. For example, in the sub-tree relating to treatments in the hospital context, “drug” is an entity which has a relation with or is an attribute of, for example: doctors (from the point of view of treatments prescribed); patients (from the point of view of treatments given); administration (from the point of view of maintaining stocks of drugs) and so on. The entire set of drugs used can be provided for with an expression to identify each drug. In an illustrative embodiment, the parts of the expression specific to the occurrences of each drug will be located in the I₁ to I₁₅ fields as shown in FIG. 2. Thus when used in conjunction with the appropriate fields I₁ to I₁₀ it will be apparent whether the specified drug is in the context of a treatment prescribed by a doctor, a treatment received by a patient, or a stock to be held in the hospital pharmacy.

Further bytes in the expression, lower in the hierarchy can be associated with the drug to describe, for example, quantities or standard prescription types. It will be apparent whether the expression refers to a prescribed quantity or a stock quantity by reference to the context information found higher in the hierarchy. In practice, the number of discrete values allowed for each of these grouped “entity values” using the five fields I₁ to I₁₅ is approximately 200⁵=32×10¹¹. The number of permutations allowed can actually be expanded indefinitely, but in practice this has not been found to be necessary. It is noted, however, that the described model of FIG. 2 merely illustrates a principle of the data model. In an alternatively preferred embodiment, twenty-character expressions are used and the semantic significance of specific fields therein (I₁ to I₂₀) may differ significantly from those presently described in connection with FIG. 2. For example, in the alternative preferred model, “entity values” can occupy each of the two-byte elements I₁₃ to I₂₀, thereby allowing 65536⁸ discrete values (=3.4×10₃₈).

Thus, in the fifteen character expression I₁ to I₁₅, each character represents a natural language expression (e.g., English language expression) defining some aspect of the data model, and by travelling downward through the table it is possible to compose a collection of natural language expressions which represents the complete specification of an entity, an attribute or an entity occurrence.

Referring again to FIG. 1, the interface database 102 is also configured to store said multi-character expressions in an expression set table linking each element of each expression with a natural language phrase relating the expression to a hierarchical level and a position in a data model.

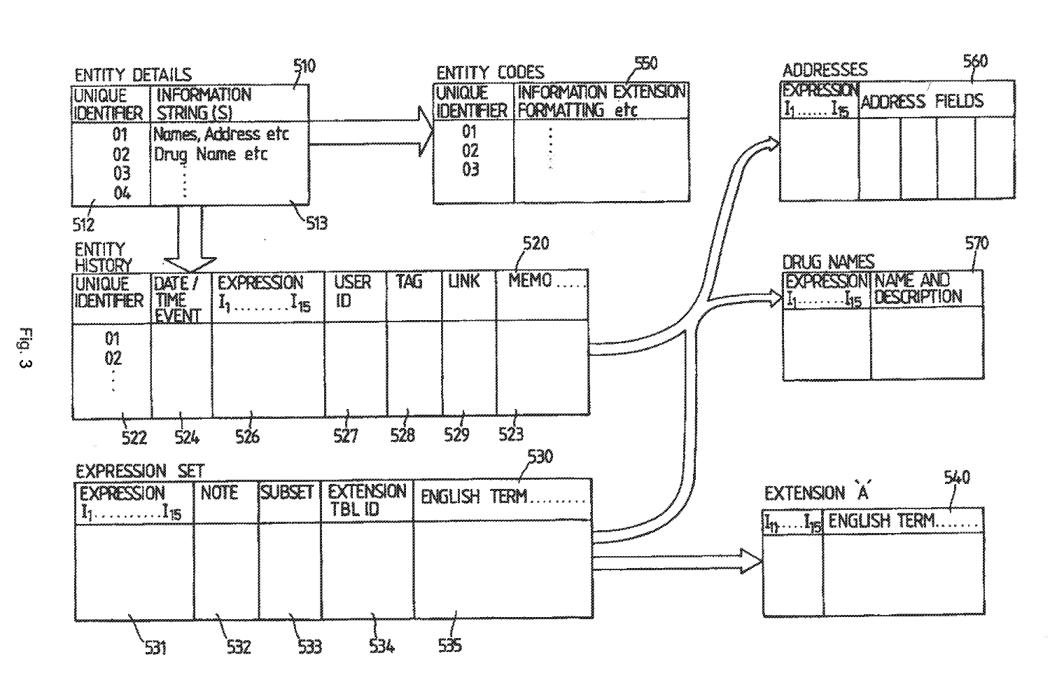

An overview of the use of an expression set together with the implementing tables that comprise an illustrative embodiment of the database system of the present invention is now described with reference to FIG. 3.

Every occurrence of an entity about which information must be stored is recorded in the entity details table 510. Each occurrence of each entity is given a unique identifier 512 that is assigned to that entity occurrence, and information about the entity is stored as a value expression information string 513. Examples of value expressions are the character strings giving names, street addresses, town, county, country etc., or drug name, manufacturer's product code etc. These details are essentially alphanumeric strings which themselves contain no further useful hierarchical information and are treated solely as character strings.

The unique identifier 512 of each entity occurrence in the entity details table 510 provides a link to an entity history table 520 where entry of, or update to the entity occurrence status is stored. In this table, the event updating the database is given a date and/or time 524, an expression 526, and the unique identifier 522 to which the record pertains, and may include other information such as the user ID 527 of the person making the change.

In the entity history table 520, various details of the event being recorded may not be available, or may have no relevance at that time. For example, a new patient in a designated hospital may be admitted, and some details put on record, but the patient is not assigned to any particular doctor or ward until a later time. Additionally, some information may be recorded which is completely independent of the user view or other context information. Thus the event is logged with only relevant bytes of the expression encoded. Bytes for which the information is not known, or which are irrelevant to the event are non-deterministic and are filled with the wild card character, “#”.

The entity history table 520 may also include an event tag field 528 which can be used in conjunction with a corresponding field in an episode management table to be described hereinafter. It will indicate which coding activity was being carried out when the expression was assigned to the entity. For example, this tag could indicate whether the coding was carried out during an initial assessment, an update, a correction, a re-assessment, etc. This tag also orders entity codes into event groups. For example, in the medical context, when a person enters the system as a patient, they initiate an admission. An episode can have many spells, (such as a period of treatment on ward A, followed by a period on Ward B) and a spell can consist of many events (such as contacts with the attending physician, procedures, tests). What is more, a patient can be involved with more than one episode at a time (for example out-patient episodes with different hospitals pertaining to different illnesses), and under each episode, more than one spell at a time (e.g. involvement with more than one department of each hospital, each dealing with different aspects of each illness). Many organizations need to store this sort of information for costing and auditing purposes. By coding this information into an expression, it will be possible to browse this information.

The entity history table may also include a link field 529 which is designated to link related groups of codes allocated during a particular entity-event-times. For example, in a social services application, a home visit, a visit date, miles travelled and the visitor could all have an expression associated with the visit event. The link field will link these expressions together. Alternatively, the event tag field may also cater for this function.

A memo field 523 may also be included in the entity history table to allow the user to enter a free text memorandum of any length for each code allocated to an entity. In effect, every time a field is filled, a memo can be added.

The expression set of the entire database is recorded in a third table, the expression set table 530. This encodes each expression against its natural language meaning, and effectively records the data model as defined by the hierarchical structure of FIG. 2. There is a natural language meaning for each byte of the expression, each byte representing a node position in the data model tree, and the precise significance of every occurrence of every entity or attribute is provided by concatenating all natural language meanings for each byte of the expression: e.g. and again in the context of the NHS in the United Kingdom, —Presentation Data Type—Administrator's View—Region 1—HospitalNo2—Doctor Record—Name—DoctorID1. It will be appreciated that the terms within this expression set table may be appropriate for the environment of which the databases are provided. For example in a US healthcare environment, while the terms used may differ from those used in a UK healthcare environment, the expression set table still provides a link in a natural language to which the user is familiar to the underlying data which is provided in a more complex form.

The expressions may include expression extensions which map a sub-tree onto the main tree as are discussed in more detail in aforementioned GB 2293697B and GB 2398143B. For convenience, these extension expressions can be located within the expression set table 530 (the extension entries being identified by the byte I₁, or could be located in a supplementary table (not shown), in which the pointer fields I₁₁ to I₁₅ of the main expression are used as the first fields I₁ to I₅ of the extension expression.

The entity history table 520 and the expression set table 530 may each include an extra field holding a version code. In the entity history table, this would indicate a version number of the expression in use at the time the record was created; in the expression set table, expressions may be varied over time according to the version code given. This allows the structure of the hierarchy to change over time without necessarily introducing new expressions. This assists in maintaining backward compatibility of recorded data.

As can be seen from FIG. 1, the database system 100 also provides a user query interface 101, the user query interface 101 being configured to effect generation of data query expressions, the data query expressions being parsed only against the interface database 102 to effect a return of data reflective of the data query expressions.

The present invention offers significant advantages in the execution of reporting and database querying functions particularly for multiple users or multiple classes of users.

To answer a given query, the database system defines a query expression comprising fifteen bytes (I₁ to I₁₅) which correspond with the expressions as stored in the entity history table 520 and expression set table 530. The query expression will include a number of deterministic bytes and a number of non-deterministic bytes. The non-deterministic bytes are effectively defined as the wild-card character “#”-“matches anything”. The deterministic bytes are defined by the query parameters.

For example, a simple query might be: “How many patients are presently registered at hospital X”. To answer this query, the query expression imposes deterministic characters in fields I₁, (=NHS), I₄ (=hospital identity), I₆ (=patients). Other context information may be imposed by placing deterministic characters in bytes I₂ (=presentation information). All other bytes are non-deterministic and are set to “#”. The database scans through the expression set table matching the deterministic characters and ignoring others. It should be noted that in the preferred embodiment, the expression set table is maintained in strict alphanumeric sequence and thus very rapid homing in on the correct portions of the database table is provided where high-order bytes are specified. This will normally be the case, since the hierarchical nature of the expression set will be arranged to reflect the needs of the organization from which the data was retrieved. The database system can then readily identify all the tuples of the expression set table providing a match to the query expression.

A significant advantage of the database structure will now become evident. The answer to the initial query has effectively homed in on one or more discrete portions of the expression set table and counted the number of tuples matching the query expression. Supposing that the user now requires to “progressively query” by stipulating additional conditions: “How many of those patients are being prescribed drug Y” requires only the substitution of the non-deterministic character “#” with the appropriate character in the requisite field In of the expression to change the result. Similarly, carrying out statistical analysis of other parameters, such as: “How many patients were treated by doctor Z with drug Y” can rapidly be assessed. It should be understood that progressively narrowing the query will eventually result in all bytes of the query expression becoming deterministic and yielding no match, or yielding a single patient entity match whose details can then be determined by reference to the entity details table 510 (or the appropriate memo field).

It should now be clear that the key to the speed of result of the statistical querying function is the construction of the expression set table. When imposing conditions on various attributes of an entity, i.e. by setting a deterministic character in a byte of the query expression, the relevant data will be found in portions of the table in blocks corresponding to that character. Progressive querying requires only scanning portions of the table already identified by the previously query. Even where a higher level context switch takes place, relevant parts of the expression set table can be accessed rapidly as they appear in blocks which are sequenced by the expression hierarchy.

Scanning the table can be achieved most efficiently by recognising that only the highest order, deterministic byte of the query expression need be compared with corresponding bytes of each record in the expression set table until a first match is obtained. Thereafter, the next highest order byte must be included, and so on until all deterministic bytes are compared. This results from maintaining a strict alphanumeric ordering to the table.

Another type of querying relates to examining the historical aspects of the database through the use of entity history table 520. For example, the query may be, “In the last year, what drugs and quantities have been prescribed by doctor X”? To answer this query, the query expression is formulated in the same manner as before with regard to the expression set table 530, imposing deterministic bytes in the appropriate places in the query expression. This will include one or more “lowest order” bytes in I₁₁ to I₁₅ which actually identify a doctor, and non-deterministic characters against the drug fields. This time, however, the entity history table 520 is scanned, in a similar manner, seeking only matches of deterministic characters. In a preferred embodiment, the entity history table 520 will be maintained in chronological sequence and thus the search can be limited to a portion of the table where date limitations are known and relevant. Matches of deterministic characters will be found throughout the table where a relevant event relating to prescription of a drug by doctor X is found. Note that the entity history table 520 may include other fields which can be used to impose conditions on the query, such as the user ID of the person entering the record.

A further type of querying relates to analysis of the records pertaining to a single entity value: the entire medical record of patient X. In the preferred embodiment, patient X would be identifiable from the entity details table 510.

The query would initially involve searching for the patient's name to locate the unique identifier (unless that was already known). Once the unique identifier for a patient was known, then the entire entity history table can be scanned very rapidly for any entry including the unique identifier. The strengths of the present invention will then be realized in that the output from this scan will provide a number of entries each of which carries all of the relevant information about that patient incorporated into the extracted expression bytes I₁ to I₁₅. The entire patient's record can then be “progressively queried” without recourse to any further searching operation on the main entity history table 530. Specific details of the patient's treatments, doctors, hospital admissions, prescriptions etc. are all very rapidly available at will be assertion of appropriate deterministic bytes in the expression I₁ to I₁₅.

It is noted that the event history table will include many records where the expression stored in the record contains many non-deterministic bytes. For example, where a doctor X prescribes a patient Y with drug Z, other bytes of the expression may be either not known, or not relevant. For example, the patient may have been assigned to a ward W in the hospital which could be identified by another byte. However, this venue in which the treatment took place might be: a) unknown; b) known but not relevant to the record; or c) automatically inferable from the context of the person making the record entry.

Whether this information is included in the record is stipulated by the users; however, it will be noted that it does not affect the result of the query whether the byte in the entity history table relating to WARD W is deterministic or non-deterministic, because the query expression will set that relevant byte to non-deterministic unless it is stipulated as part of the query.

When the database system has extracted all of the records of the entity history table matching the query expression, it preferably saves these to a results table for further querying, or progressive browsing. For example, the results table can then be analysed to identify which treatments were made at an individual hospital or by an individual doctor by setting additional conditions on particular bytes of the query expression. Memo fields can be extracted to view comments made at the time of treatment. It can be seen that the results table formed in response to the initial query actually contains all of the information relevant to a given patient's treatment, and not just the answer to the initial query “What drugs have been prescribed to patient X”?

In summary, the information of the database is stored in such a manner that data for a query may be extracted far more rapidly than relational database storage schemas such as those used in databases 103, and with an expression for each extracted record. The presence of this expression in the query result has an important effect. A unique reporting benefit gained is the scope for progressive querying and “interactive reporting”. In this way a set of results that is the result of a first search query represents a data set that provides the searchable data for a second search query. This searchable data set has been qualified or constrained by the matching of the deterministic criteria of the first search query against the interface database.

When a database query is executed to provide information for a report, the answer will be made up of a number of expression records. This subset of expressions inherits all the structural information held in the main expression set.

As a general example: a detailed report on the number of severe hallucination instances in a given geographical area during the past year might return a subset of 12,000 expressions. Because these are full expressions, higher and lower level information is also inherent in this subset. Further investigation of the answer through browsing the returned hierarchy might reveal that 70% of cases were male, or 30% of cases occurred in the prison service, etc. Similarly, a high level report on the number of instances of hallucination in a particular organization might return a subset of 9,000. More detailed information will be inherent in this retrieved subset. By progressive querying of this subset, it may transpire that 90% of mild occurrences were in planning departments or that 5% of severe occurrences were in education departments. The processing time required to browse this information with further, more detailed “sub-queries” is substantially speeded up over prior art systems simply because the expression set readily provides all the lower level information.

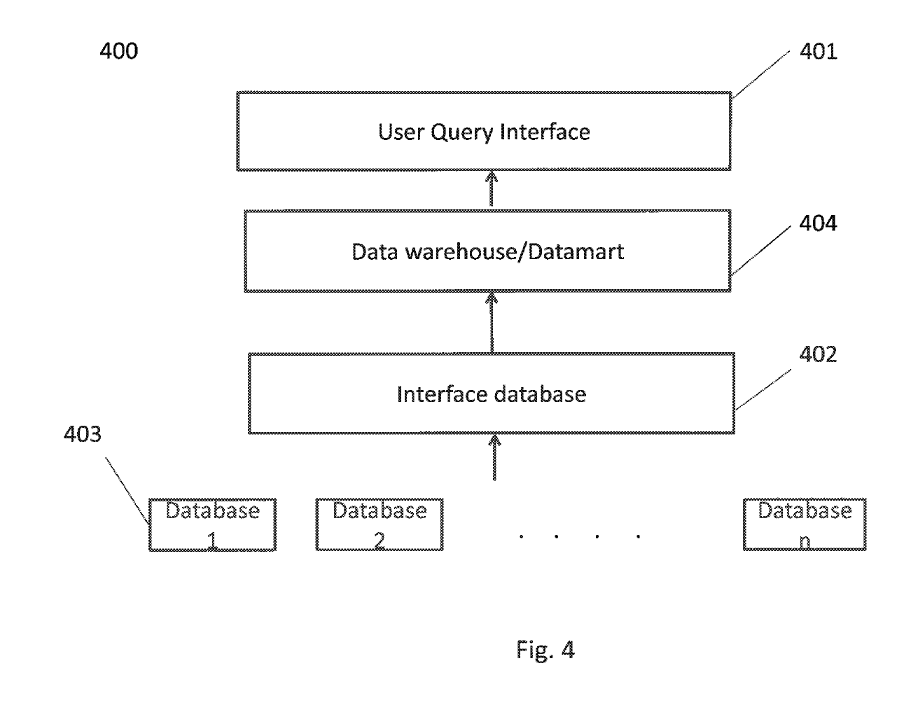

FIG. 4 shows another an exemplary database system described in the present teaching. In particular, FIG. 4 shows the use of a data warehouse or data mart 404 in conjunction with a data system such as that outlined in FIG. 1 and described previously. In this configuration the interface database 402 is configured to interface with the databases 403 in a similar way to the interface database 102 and databases 103 of FIG. 1. By providing such an interface database 402 it is possible to present data that was originally stored in each of the data bases in a generic fashion to the data warehouse 404. A user query entered through a graphical user interface or any other interface 401 can be used to extract data from the data warehouse 404, or indeed in certain implementations may bypass the data warehouse 404 and directly interrogate the interface database 402.

It will be appreciated that traditional data warehouses typically use a process referred to as ‘ETL’—standing for extract, transform and load—to import data from external databases. Within the context of the present teaching an interface database, such as that heretofore described may be used in conjunction with a data warehouse as an interface between the data warehouse and the data sources that are usually used to populate the data warehouse. By using an interface database in accordance with the present teaching it is possible to transform data during the ETL process to support the flexible addition of new data sets and data sources. For example in a traditional data warehouse as new databases are added the data model used within the data warehouse has to evolve to accommodate it and this might entail re-working of all pre-existing database transformations. Similarly the addition of new data items for reporting purposes may require major rework of pre-established reporting cubes and queries. In contrast, using an interface database and its data elements in accordance with the present teaching will allow a revision of the underlying data model used in the data warehouse without reference to the external databases. Another advantage is that new data items may be incorporated or added for aggregated reporting with no reworking of pre-existing reports required.

Furthermore, using an interface database which includes unique, multi-character expressions associated with the data entities of at least one of the databases that are used to populate the data warehouse it is relatively easy to generate new data items during the transformation process of the ETL. In this way it is possible to pre-process data to support applications such as reporting. For example, ‘length of stay in hospital’ is a widely used measure in the healthcare industry and is easily derivable by calculating the interval between dates of admission and discharge to hospital. Upon import of data items ‘date of admission’ and ‘date of discharge’ the interface database can generate an additional multi-character expression ‘length of stay’ which can be placed in the expression database. Once there ‘length of stay’ becomes available as a selection criterion for reporting and analysis either on its own or in combination with any other set of selection criteria. So, for example, a doctor may wish to retrieve details of all patients with a diagnosis of heart failure and a length of stay of greater than 3 days. Whilst it is also possible to pre-process data using conventional data import methods, the decision to generate additional data such as this example necessarily entails creation of an additional structure to the receiving database and use of the generated data item would require considerable re-work of pre-existing analytical and reporting queries. The definition of the multi-character expressions that are used within the interface database is determined by the nature of the data that is in the source database. In this way the source data drives the definition of the length of the multi-character expressions and the mapping of data from the source databases can be effected in a hierarchical fashion. For example in the context of healthcare, patient identifiers provide a useful unique character on which to parse data relevant to that patient.

Finally, unlike traditional data warehouses the interface database is database-type independent and as the expressions originate from disparate heterogeneous sources, the interface database provides a homogenous representation of same. Although in the case of any particular implementation a conventional database may be used to store the data this is for convenience only and is not intrinsic to the implementation.”

For example, assume there exists 2 sets of terms in two database tables in two separate databases, all of which appear to be closely related, such as the following:

| Database | Term |
|---|---|
| 1 | Medication X |
| 1 | Med X |
| 1 | Med X dose Y |
| 1 | Med x dose y |
| 1 | Med X dose z |
| 2 | Medication x |
| 2 | Medication X |
| 2 | Med x |
| 2 | Med. X, dose y |
| 2 | Med x dose y |
| 2 | Med. X dos z |
| 2 | MedX |

In order to correlate data from Database 1 with data from Database 2, traditional approaches would decide that all the above terms are equivalent to a single selection from the list, say ‘Medication X’, and so the import process would map all non-‘Medication X’ terms onto this option.

A variant of this approach would be to identify some external or new standard term e.g. ‘MEDICATION X’ and map all terms from both tables onto this.

A more complex approach would be to map all of the terms onto a sample of selections. These could either be a subset of the terms in the table or externally-defined variants. In the former case, for example, if we thought that reference to a dosage in the term was potentially significant, we might decide to map all options containing no reference to a dosage to ‘Medication X’ and all options referring to a dosage to ‘Med X dose z’. Or in order to make clear that such a mapping is imperfect we could define two external categories and map onto those e.g. where dosage is not referenced map all options onto ‘Medication X (does unspecified)’; and those where dosage is referenced to the term ‘Medication X (dosage specified).

Obviously, this option could also be combined with a version of Option 1, so that, for example, the mapping partially used terms already in the table, partly used external standard terms and partly used newly-defined terms.

While these traditional approaches can and do work, there are problems associated with same including:

1. There is a loss of transparency. Whichever approach is taken there will be a loss of transparency in the end product, in the sense that an end user who was not part of the decision-making process regarding which mapping to undertake will not be able to detect the decisions made.
2. There is a risk of loss of semantic information. Any decision to map runs the risk that the fine-detailed differences between options might be lost. Suppose that ‘Medication X’ means ‘high dose of X’ whereas ‘Medication x’ means ‘low dose of x’, then mapping of both options onto ‘Medication X’ will lose the distinction.
3. There is a risk of loss of data source information. Once the mapping has been undertaken and the data consolidated it may not be clear to the end user from which database any specific instance originated.
4. Complex decisions have to be made a priori. Decisions regarding mapping are irrevocable and have to be made prior to any empirical investigation as to their impact. Suppose that whether terms were upper or lower case turned out to be of more semantic significance than dosage reference this could never be discovered if a mapping based upon dosage reference was undertaken.
5. In many cases, whilst none of the issues listed may be sufficiently worrisome to prevent work proceeding, the sheer volume of a priori decisions that may need to be made when merging databases where there are many sets of terms to be integrated, may be sufficiently prohibitive to prevent integration ever taking place.

The present teaching and its use of multi-character expressions provides a broader set of options that could be used as alternative or in conjunction with the techniques described above. Rather than importing data using a strict mapping regime, the present teaching adopts a hierarchical grouping methodology to facilitate the import of the data to the interface database.

A first option is to coin a new term e.g. ‘MEDICATION X’ and code this as the parent term to all the medication options in our example, as follows (code in brackets):

```
MEDICATION X (code 1)
      Medication X (11)
      Med X (12)
      Med X dose Y (13)
      Med x dose y (14)
      Med X dose z (15)
      Medication x (16)
      Med x (17)
      Med. X,dose y (18)
      Med x dose y (19)
      Med. X dos z (20)
      MedX (21)
```

Based on this approach, an end user would have the choice of grouping all options together by querying based upon the parent code; or grouping any subset of child options together as equivalent for purposes of a specific query. A more refined version of the above would be to use natural groupings of terms that are very closely related in meaning. For example, the above list could be resolved into a hierarchical structure such as:

```
MEDICATION X (1)
      MEDICATION X DOSE UNSPECIFIED (11)
            Medication X (112)
            Med X (113)
            Med x (114)
      MEDICATION X DOSE Y (12)
            Med X dose Y (121)
            Med x dose y (122)
            Med. X,dose y (123)
      MEDICATION X DOSE Z (13)
            Med X dose z (131)
            Med. X dos z (132)
```

Rather than searching on everything or alternatively hunting through a long list, the user now has a set of intuitive groupings to select from and shorter lists within each. Furthermore, if data source is considered sufficiently important it would be possible to construct two such hierarchies, with parent terms ‘DATABASE 1’ and ‘DATABASE 2’ respectively.

It will be appreciated that key features of this approach are that:
Potentially, there is no information loss, even of data source information, since this could in principle be encoded either within a classification or as a separate attribute. Options can be retained in their rawest form if desired.
Natural groupings can be formed into hierarchical classifications that lend themselves to easy query-writing.
Whilst there is still work involved in grouping sets of options together, high level groupings can often be easily agreed upon and the finer niceties can be left unresolved by grouping low-level terms below them. This approach permits different groupings/combinations of selections to be used for different types of queries, rather than the user being forced to resolve all classificatory and mapping issues up front.
The above features, whilst beneficial, do not mean that it is inadvisable for any mapping to be undertaken. If no mapping at all is done then there is a risk of generating very long lists of options, many of which are ‘obviously’ the same in meaning e.g. ‘Med x dose y’ and ‘Med x, dose y’.

It will be appreciated that use of ETL techniques per the present teaching can be effected in combination with mapping techniques already known. In practice the choice of methods is rarely likely to be an either/or—a combination of mapping and grouping methods may be the most pragmatic approach. Indeed, the extent to which each is used may vary from data element to data element—where mappings are simple and obvious then it makes sense to agree upon a definitive set of categories upfront; where it is less obvious and complex then a combination of groupings and mappings may be more appropriate.

It will be appreciated that in an implementation such as shown in FIG. 4, the interface database may be configured as a piece of middleware that sits in between the sending databases—such as those that are provided as traditional SQL/Oracle database—and one or more data warehouses/datamarts. Using such an interface database which comprises unique, multi-character expressions associated with the data entities of the traditional database it is possible to export the data which has already been transformed to a generic data format. In this way it presents a single standard interface to external databases. Consequently:

(i) importing from additional data sources new additional bottom layer databases, 403 involves no model adaptation (as previously discussed)
(ii) any change to the data model in a receiving data warehouse top layer 404 can be accommodated by a single modification of the export from the interface database 402 rather than requiring every sending database basic SQL etc databases to modify what it does and
(iii) multiple different data models can effectively be supported by a single data aggregation interface database 402, since the data could be exported in a variety of formats or structures to a range of applications/data models.

It will be appreciated that implementations in accordance with the present teaching can be readily realized both in software, and in hardware.

It will be understood that the database querying essentially requires byte wide comparison of the expressions I₁ to Iₙ (I₁ to I₁₅ simply used as an example above). An extremely fast coprocessor ASIC could thus be manufactured which includes up to n eight-bit comparators in parallel. In practice, querying would never require all fifteen bytes to be compared, as most queries involve the setting of a large number of the bytes to a non-deterministic state, thus in practice requiring fewer parallel circuits and enabling simplification of the design of a dedicated co-processor.

It will be understood that the database querying that is possible using an architecture in accordance with the present teaching may allow using the interface database to access in a single user query data originally stored in two or more of the plurality of databases. To ensure that the data in the interface database correctly reflects the data that is stored in the underlying databases the present teaching may provide maintaining the plurality of databases concurrently with maintenance of the interface database. Other implementations may provide updating the interface database on a determination that one of the plurality of databases has been updated.

The interface database comprises one or more data elements provided in a flat structure. In another arrangement the interface database comprises one or more data elements provided in a relational model. In such a configuration the present teaching provides for a storing of discrete ones of the plurality of unique, multi-character expressions in distinct tables within the interface database.

While it is not intended to limit the present teaching to any one specific arrangement it will be appreciated that multiple types of queries that were heretofore difficult to generate in a simple user interface may now be provided. For example it is possible to progressively generate a plurality of queries to extract data from the interface database, a first query providing a subset of the plurality of unique, multi-character expressions, the subset forming a dataset for interrogation by a second query. In this way and because it is possible to store the source of each data element as a multi-character expression it is also possible to limit queries to e.g. data element X only if drawn originally from database Y e.g. diagnosis of cancer but only if made by the oncology department and not by the primary care physician. Another arrangement is generating a user query in the form of a syntactically correct statement, the database system being configured to interrogate the user query and transform the user query to identify one or more of the plurality of unique, multi-character expressions which satisfy the query. A further arrangement may provide storing a plurality of individual unique, multi-character expressions having data related to a specific person and parsing the plurality of unique, multi-character expressions to extract information not wholly stored in any one of the unique, multi-character expressions. Another arrangement may provide storing a plurality of individual unique, multi-character expressions having data related to a specific event and parsing the plurality of unique, multi-character expressions to extract information not wholly stored in any one of the unique, multi-character expressions and defined within a queried data window. In this example it is now possible to perform a query around a specified target time “width of now” ΔT.

Other implementations that may be provided in accordance with the present teaching include creating a hierarchical tree-like database such as described above with reference to FIG. 1 or 4 and using the interface database and its unique multi-character expressions to store an expression table and entity history table for the contributing underlying databases. It is also possible in accordance with the present teaching to provide a controlling of the output of a display of search results according to “event views” and “key views or indeed to provide a profile of a user of the system and then controlling the output of display of search results according to the individual user.

While it is not intended to limit the present teaching to any one specific implementation it will be appreciated that the architecture is typically a distributed architecture with at least one of the at least one database and interface database being provided as a cloud database.

Therefore, it can be seen from the above that all the benefits related to extracting data rapidly from a database with a hierarchical tree-like structure as described above can be applied to existing databases with the addition of an interface database between these existing databases and a query user interface. Any querying performed by a user is no longer limited by the data structure or model used in the existing databases since querying is only indirectly performed on these existing databases and is directly performed on the interface database. Furthermore, because faster extraction and querying of data can be performed on interface database a larger volume of data related to numerous organizations can be stored therein.

The words “comprises/comprising” and the words “having/including” when used herein with reference to the present invention are used to specify the presence of stated features, integers, steps or components but does not preclude the presence or addition of one or more other features, integers, steps, components or groups thereof.

The present teaching is not limited to the embodiments hereinbefore described but may be varied in both construction and detail.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

1. A method of operating a database system comprising the steps of:
providing access to at least one database, each of said at least one database having a structure based on a respective database model and storing a plurality of data entities having attributes and occurrences within the structure;
providing an interface database, the interface database populated with a plurality of unique, multi-character expressions associated with the data entities of the at least one database, whereby for the interface database, the plurality of unique, multi-character expressions are defined by assigning to every entity, every attribute and every entity occurrence a unique, multi-character expression, the expression having a predetermined hierarchical structure which defines the relationship between each entity, attribute and entity occurrence with every other entity, attribute and entity occurrence in the interface database and storing said expressions in an expression set table linking each element of each expression with a natural language phrase relating the expression to a hierarchical level and a position in a data model.

2. The method of claim 1, comprising providing a user query interface, the user query interface being configured to effect generation of data query expressions, the data query expressions being parsed only against the interface database to effect a return of data reflective of the data query expressions.

3. The method of claim 2, wherein a data query expression comprises characters which correspond to the expressions stored in the expression set table of the interface database, the characters of the data query expression including deterministic characters and non-deterministic characters.

4. The method of claim 3, wherein performing a query comprises scanning the expression set table of the interface database using the data query expression to match the deterministic characters and ignore the other characters.

5. The method of claim 4, wherein performing a progressive query comprises replacing at least one non-deterministic characters of the data query expression with a deterministic character and scanning a portion of the expression set table identified by a result of a previous query using the modified data query expression.

6. The method of any preceding claim further including the step of storing, in an entity history table of the interface database, a plurality of records, each record including the value of at least one attribute of an entity occurrence as defined in accordance with the data model which is defined in the expression set table.

7. The method of claim 6 further including the step of, for each record in the entity history table, including a field indicating the chronology of the record with respect to other records.

8. The method of claim 6 further including querying the interface database to determine the status of an entity, or class of entities by the steps of:
for a given set of query parameters, defining the characters of the expression which are deterministic to the query and those which are not deterministic to the query to define a query expression containing deterministic and non-deterministic characters;
scanning at least a selected portion of the entity history table to examine the expression contained in each record;
matching every deterministic character of the query expression with every deterministic character in the examined record; and
where each deterministic character of the query expression matches the respective record expression, extracting the record to a results table.

9. The method of any preceding claim wherein the at least one database comprises a plurality of databases.

10. The method of claim 9 wherein at least two of the plurality of databases differ in their database management system, each database management system defining a set of programs that enable a user to store, modify, and extract information from the respective database.

11. The method of claim 10 comprising using the interface database to allow a user to access data stored in the plurality of databases without using the database management system specific to the plurality of databases.

12. The method of claim 10 wherein the database management systems are selected from one or more of those provided by Oracle, FoxPro, IBM DB2, Linter, Microsoft Access, Microsoft SQL Server, MySQL, PostgreSQL and SQLite.

13. The method of any preceding claim comprising converting the data stored in the plurality of databases into unique, multi-character expressions for storage in the interface database.

14. The method of claim 13 comprising iteratively accessing data within the plurality of databases to convert data not already converted and stored as unique, multi-character expressions in the interface database to unique, multi-character expressions for storage in the interface database.

15. The method of any preceding claim comprising using the interface database to access in a single user query data originally stored in two or more of the plurality of databases.

16. The method of any preceding claim comprising maintaining the plurality of databases concurrently with maintenance of the interface database.

17. The method of claim 16 comprising updating the interface database on a determination that one of the plurality of databases has been updated.

18. The method of any preceding claim wherein the interface database comprises one or more data elements provided in a flat structure.

19. The method of any preceding claim wherein the interface database comprises one or more data elements provided in a relational model.

20. The method of any preceding claim wherein at least one of the at least one database and interface database is provided as a cloud database.

21. The method of any preceding claim comprising storing discrete ones of the plurality of unique, multi-character expressions in distinct tables within the interface database.

22. The method of any preceding claim comprising progressively generating a plurality of queries to extract data from the interface database, a first query providing a subset of the plurality of unique, multi-character expressions, the subset forming a dataset for interrogation by a second query.

23. The method of any preceding claim comprising generating a user query in the form of a syntactically correct statement, the database system being configured to interrogate the user query and transform the user query to identify one or more of the plurality of unique, multi-character expressions which satisfy the query.

24. The method of any preceding claim comprising storing a plurality of individual unique, multi-character expressions having data related to a specific person and parsing the plurality of unique, multi-character expressions to extract information not wholly stored in any one of the unique, multi-character expressions.

25. The method of any preceding claim comprising storing a plurality of individual unique, multi-character expressions having data related to a specific event and parsing the plurality of unique, multi-character expressions to extract information not wholly stored in any one of the unique, multi-character expressions and defined within a queried data window.

26. The method of any preceding claim comprising providing a data warehouse in communication with the interface database, the interface database presenting data that was originally stored in each of the data bases in a generic fashion to the data warehouse.

27. The method of claim 26 comprising processing a user query to extract data from the data warehouse.

28. The method of claim 27 comprising processing the user query to bypass the data warehouse and directly interrogate the interface database.

29. A database system comprising:
at least one database, each of said at least one database having a structure based on a respective database model and storing a plurality of data entities having attributes and occurrences within the structure;
an interface database, the interface database populated with a plurality of unique, multi-character expressions associated with the data entities of the at least one database, whereby for the interface database, the plurality of unique, multi-character expressions are defined by assigning to every entity, every attribute and every entity occurrence a unique, multi-character expression, the expression having a predetermined hierarchical structure which defines the relationship between each entity, attribute and entity occurrence with every other entity, attribute and entity occurrence in the interface database and storing said expressions in an expression set table linking each element of each expression with a natural language phrase relating the expression to a hierarchical level and a position in a data model.

30. The database system of claim 29 wherein at least one database and interface database are arranged relative to one another such that the interface database is layered above the at least one database whereby user queries to the data system are parsed initially to the interface database.

31. The database system of claim 29 or 30 comprising a data warehouse in communication with the interface database, the interface database presenting data that was originally stored in each of the data bases in a generic fashion to the data warehouse

32. A healthcare management system comprising:
at least one accessible database, each of said at least one accessible database having a structure based on a respective database model and storing a plurality of data entities having attributes and occurrences within the structure;
an interface database, the interface database populated with a plurality of unique, multi-character expressions associated with the data entities of the at least one accessible database, whereby for the interface database, the plurality of unique, multi-character expressions are defined by assigning to every entity, every attribute and every entity occurrence a unique, multi-character expression, the expression having a predetermined hierarchical structure which defines the relationship between each entity, attribute and entity occurrence with every other entity, attribute and entity occurrence in the interface database and storing said expressions in an expression set table linking each element of each expression with a natural language phrase relating the expression to a hierarchical level and a position in a data model.

33. A computer architecture comprising machine readable code which when executed within the computer architecture is configured to carry out the method steps of any one of claims 1 to 28.
